(19) United States
(12) Patent Application Publication
(10) Pub. No.: US 2025/0039829 A1
(43) Pub. Date: Jan. 30, 2025

(54) COORDINATION INFORMATION FORWARDING FOR SIDELINK POSITIONING

(71) Applicant: QUALCOMM Incorporated, San Diego, CA (US)

(72) Inventors: Alexandros Manolakos, Athens (GR); Mukesh Kumar, Hyderabad (IN); Kianoush Hosseini, San Diego, CA (US); Srinivas Yerramalli, San Diego, CA (US)

(21) Appl. No.: 18/716,103

(22) PCT Filed: Jan. 19, 2023
(86) PCT No.: PCT/US2023/060919

§ 371 Date: Jun. 3, 2024

(30) Foreign Application Priority Data
Feb. 17, 2022 (GR) 20220100143

(51) Int. Cl. H04W 64/00; H04L 5/00; H04W 92/18

(52) U.S. Cl. CPC H04W 64/00; H04L 5/0048; H04W 92/18

(57) ABSTRACT

This disclosure provides systems, methods, and devices for wireless communication that support coordination information associated with sidelink positioning reference signals. In a first aspect, a method of wireless communication includes generating, by a user equipment (UE), coordination information associated with sidelink-positioning reference signal (SL-PRS) scheduling, and transmitting a message including the coordination information. Other aspects and features are also claimed and described. In a second aspect, a method of wireless communication includes receiving, by a UE, a message including coordination information associated with SL-PRS scheduling, and determining whether to forward at least a portion of the message based on forwarding information included in the first message.

### CROSS-REFERENCE TO RELATED APPLICATIONS

This application claims the benefit of Greek patent application No. 20220100143, entitled, “COORDINATION INFORMATION FORWARDING FOR SIDELINK POSITIONING,” filed on Feb. 17, 2022, which is expressly incorporated by reference herein in its entirety.

### TECHNICAL FIELD

Aspects of the present disclosure relate generally to wireless communication systems, and more particularly, to sidelink positioning. Some features may enable and provide improved communications, including coordination information for improved scheduling of sidelink positioning reference signals, collision avoidance, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

With the introduction of 5th Generation (5G) or new radio (NR) networks (sometimes referred to as “5G NR” networks/systems/devices), UEs are able to have higher capability, higher data rate, higher bandwidth. Additionally, UEs are also able to operate in a variety of architectures that provide dual connectivity. As devices continue to become more commonplace, improve, and “do more”, scheduling access to a wireless medium and avoiding conflicts becomes more difficult, such as when multiple devices are densely co-located.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes generating, by a user equipment (UE), first coordination information associated with sidelink-positioning reference signal (SL-PRS) scheduling. The first coordination information indicates one or more preferred SL-PRS resources of the UE, one or more non-preferred SL-PRS resources of the UE, one or more previous SL-PRS conflicts identified by the UE, one or more future SL-PRS conflicts identified by the UE, or a combination thereof. The method also includes transmitting a first message including the first coordination information.

In an additional aspect of the disclosure, an apparatus includes at least one processor and a memory coupled to the at least one processor. The at least one processor is configured to generate first coordination information associated with SL-PRS scheduling. The first coordination information indicates one or more preferred SL-PRS resources of a UE, one or more non-preferred SL-PRS resources of the UE, one or more previous SL-PRS conflicts identified by the UE, one or more future SL-PRS conflicts identified by the UE, or a combination thereof. The at least one processor is further configured to initiate transmission of a first message including the first coordination information.

In an additional aspect of the disclosure, an apparatus includes means for generating first coordination information associated with SL-PRS scheduling. The first coordination information indicates one or more preferred SL-PRS resources of a UE, one or more non-preferred SL-PRS resources of the UE, one or more previous SL-PRS conflicts identified by the UE, one or more future SL-PRS conflicts identified by the UE, or a combination thereof. The apparatus further includes means for transmitting a first message including the first coordination information.

In an additional aspect of the disclosure, a non-transitory computer-readable medium stores instructions that, when executed by a processor, cause the processor to perform operations. The operations include generating first coordination information associated with SL-PRS scheduling. The first coordination information indicates one or more preferred SL-PRS resources of a UE, one or more non-preferred SL-PRS resources of the UE, one or more previous SL-PRS conflicts identified by the UE, one or more future SL-PRS conflicts identified by the UE, or a combination thereof. The operations further include initiating transmission of a first message including the first coordination information.

In an additional aspect of the disclosure, an apparatus configured for wireless communication includes an interface, such as a wireless interface, and at least one processor. The at least one processor is configured to generate first coordination information associated with SL-PRS scheduling. The first coordination information indicates one or more preferred SL-PRS resources of a UE, one or more non-preferred SL-PRS resources of the UE, one or more previous SL-PRS conflicts identified by the UE, one or more future SL-PRS conflicts identified by the UE, or a combination thereof. The interface is configured to transmit a first message including the first coordination information.

In an additional aspect of the disclosure, a method for wireless communication includes receiving, by a first UE, a first message including first coordination information associated with SL-PRS scheduling. The first coordination information indicates one or more preferred SL-PRS resources of the first UE, one or more non-preferred SL-PRS resources of the first UE, one or more previous SL-PRS conflicts identified by the first UE, one or more future SL-PRS conflicts identified by the first UE, or a combination thereof. The method further includes determining whether to forward at least a portion of the first message based on forwarding information included in the first message.

In an additional aspect of the disclosure, an apparatus includes at least one processor and a memory coupled to the at least one processor. The at least one processor is configured to receive a first message including first coordination information associated with SL-PRS scheduling. The first coordination information indicates one or more preferred SL-PRS resources of a UE, one or more non-preferred SL-PRS resources of the UE, one or more previous SL-PRS conflicts identified by the UE, one or more future SL-PRS conflicts identified by the UE, or a combination thereof. The at least one processor is configured to determine whether to forward at least a portion of the first message based on forwarding information included in the first message.

In an additional aspect of the disclosure, an apparatus includes means for receiving a first message including first coordination information associated with SL-PRS scheduling. The first coordination information indicates one or more preferred SL-PRS resources of a UE, one or more non-preferred SL-PRS resources of the UE, one or more previous SL-PRS conflicts identified by the UE, one or more future SL-PRS conflicts identified by the UE, or a combination thereof. The apparatus further includes means for determining whether to forward at least a portion of the first message based on forwarding information included in the first message.

In an additional aspect of the disclosure, a non-transitory computer-readable medium stores instructions that, when executed by a processor, cause the processor to perform operations. The operations include receiving a first message including first coordination information associated with SL-PRS scheduling. The first coordination information indicates one or more preferred SL-PRS resources of a UE, one or more non-preferred SL-PRS resources of the UE, one or more previous SL-PRS conflicts identified by the UE, one or more future SL-PRS conflicts identified by the UE, or a combination thereof. The operations further include determining whether to forward at least a portion of the first message based on forwarding information included in the first message.

In an additional aspect of the disclosure, an apparatus configured for wireless communication includes at least one processor, and an interface, such as a wireless interface coupled to the at least one processor. The interface is configured to receive a first message including first coordination information associated with SL-PRS scheduling. The first coordination information indicates one or more preferred SL-PRS resources of a UE, one or more non-preferred SL-PRS resources of the UE, one or more previous SL-PRS conflicts identified by the UE, one or more future SL-PRS conflicts identified by the UE, or a combination thereof. The at least one processor is configured to determine whether to forward at least a portion of the first message based on forwarding information included in the first message.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station (BS) and a user equipment (UE) according to one or more aspects.

FIG. 3 is a block diagram of an example wireless communications system that supports coordination information associated with sidelink positioning reference signals according to one or more aspects.

FIG. 4 is a flow diagram illustrating an example process that supports coordination information associated with sidelink positioning reference signals according to one or more aspects.

FIG. 5 is a flow diagram illustrating an example process that supports coordination information associated with sidelink positioning reference signals according to one or more aspects.

FIG. 6 is a block diagram of an example UE that supports coordination information associated with sidelink positioning reference signals according to one or more aspects.

Like reference numbers and designations in the various drawings indicate like elements.

### DETAILED DESCRIPTION

The detailed description set forth below, in connection with the appended, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support coordination information associated with sidelink positioning reference signals. A UE may generate first coordination information associated with SL-PRS scheduling. The first coordination information may indicate one or more preferred SL-PRS resources of the UE, one or more non-preferred SL-PRS resources of the UE, one or more previous SL-PRS conflicts identified by the UE, one or more future SL-PRS conflicts identified by the UE, one or more reservations (e.g., one or more SL reservations), or a combination thereof. In some implementations, the UE may unicast, broadcast, or groupcast the first message. Additionally, or alternatively, the UE or another UE that receives the first message may schedule a positioning reference signal based on the first coordination information. In some implementations, a UE that receives the first message may determine whether or not to forward at least a portion or an entirety of the first message or the first coordination information. For example, the UE that receives the first message may determine whether or not to forward the portion or the entirety of the first message or the first coordination information based on one or more conditions. In some implementations, the UE that forwards the coordination information (or a portion thereof) may include the coordination information in a new message or package that include other similar information received from one or more UEs.

Particular implementations of the subject matter described in this disclosure may be implemented to realize one or more of the following potential advantages or benefits. In some aspects, the present disclosure provides techniques for improved message forwarding, improved scheduling of sidelink positioning reference signals, collision avoidance, or a combination thereof.

Wireless devices may share access in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

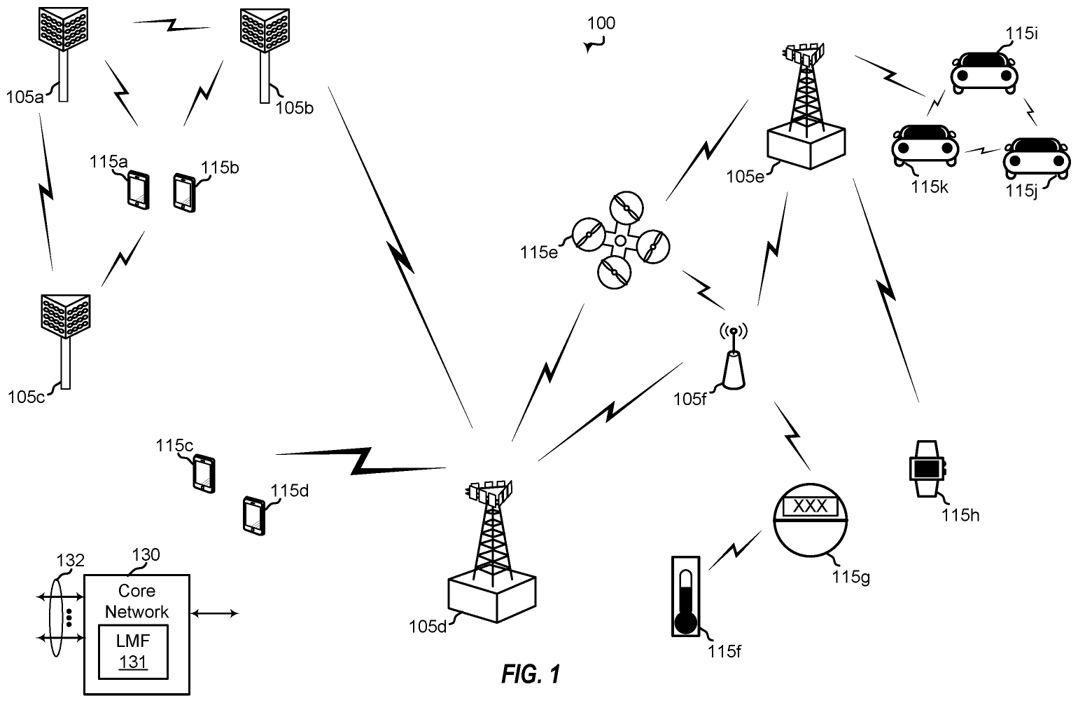

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports ultra-reliable and redundant links. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF) 131, which is an entity in the 5G Core Network (5GC) supporting various functionality, such as managing support for different location services for one or more UEs. For example the LMF 131 may include one or more servers, such as multiple distributed servers. Base stations 105 may forward location messages to the LMF 131 and may communicate with the LMF via a NR Positioning Protocol A (NRPPa). The LMF 131 is configured to control the positioning parameters for UEs 115 and the LMF 131 can provide information to the base stations 105 and UE 115 so that action can be taken at UE 115. In some implementations, UE 115 and base station 105 are configured to communicate with the LMF 131 via an Access and Mobility Management Function (AMF).

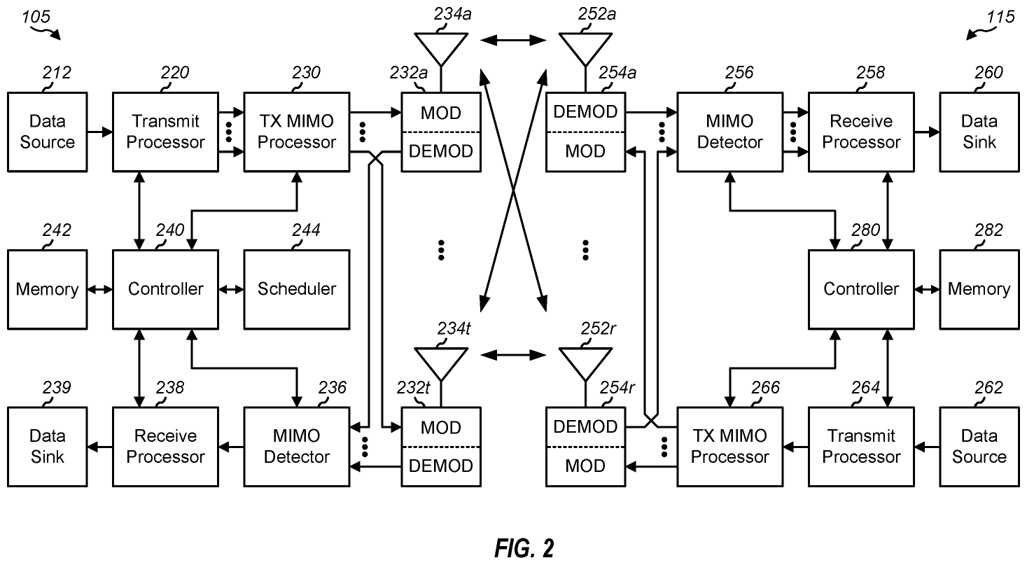

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

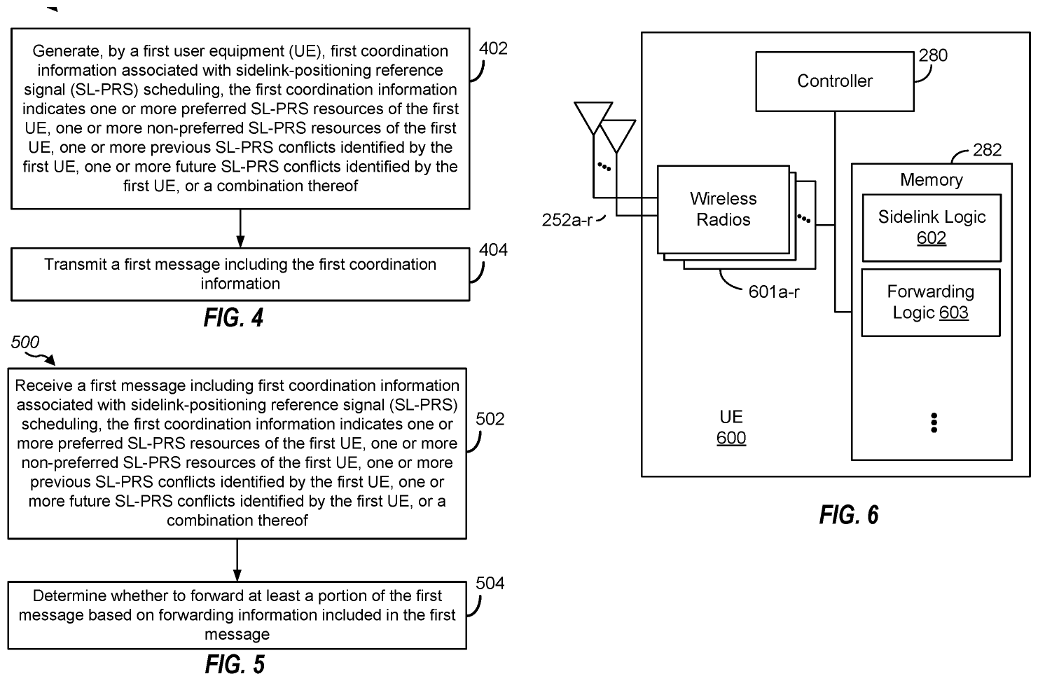

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 4, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

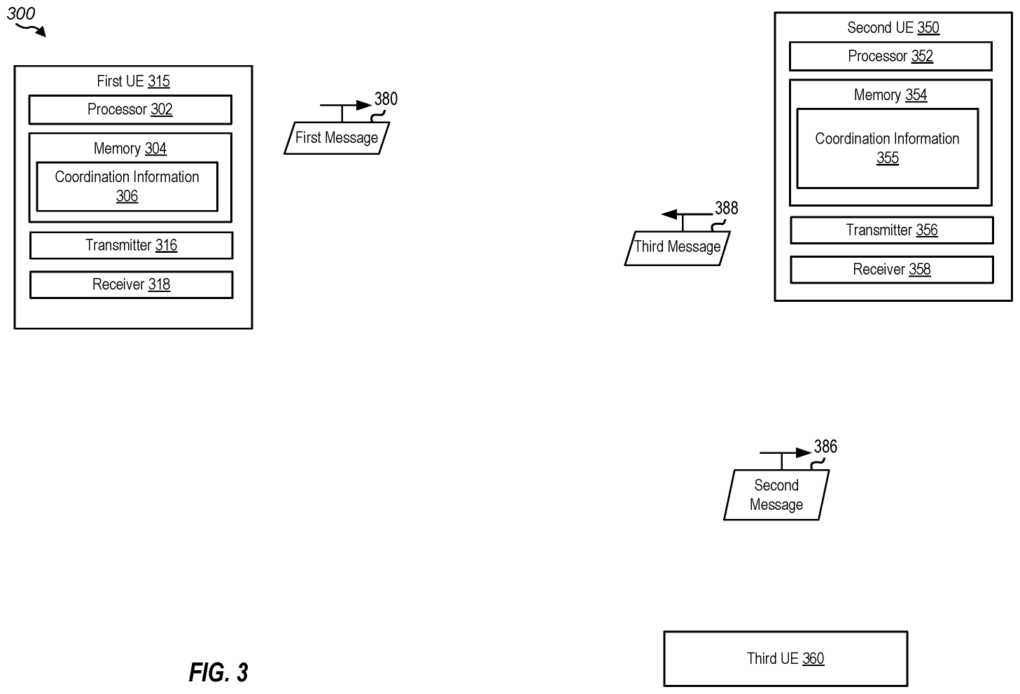

FIG. 3 is a block diagram of an example wireless communications system 300 that supports coordination information associated with sidelink positioning reference signals according to one or more aspects In some examples, wireless communications system 300 may implement aspects of wireless network 100. Wireless communications system 300 includes one or more UEs (e.g., 115), such as a UE 315 (also referred to herein as a “first UE 315”), a UE 350 (also referred to herein as a “second UE 350”), and a UE 360 (also referred to herein as a “third UE 360”). Although three UEs 315, 350, 360 are illustrated, in some other implementations, wireless communications system 300 may include more one, two, or more than three UEs. Although not shown, in some implementations, wireless communications system 300 may include one or more other devices, such as base station 105 or an IoT device, as illustrative, non-limiting examples.

UE 315 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store coordination information 306. Coordination information 306 may indicate one or more preferred SL-PRS resources of UE 315, one or more non-preferred SL-PRS resources of UE 315, one or more previous SL-PRS conflicts identified by UE 315, one or more future SL-PRS conflicts identified by UE 315, one or more reservations for SL communication, or a combination thereof. UE 315 may be configured to determine the one or more preferred SL-PRS resource, the one or more non-preferred SL-PRS resources, the one or more previous SL-PRS conflicts, the one or more future SL-PRS conflicts, one or more reservations for the SL communication, or a combination thereof. Additionally, or alternatively, coordination information 306 may indicate one or more preferred SL-PRS resources of one or more other UEs, one or more non-preferred SL-PRS resources of the one or more other UEs, one or more previous SL-PRS conflicts identified by the one or more other UEs, one or more future SL-PRS conflicts identified by the one or more other UEs, or a combination thereof.

In some implementations, UE 315 may further be configured to store PRS information, such as PRS resource information (e.g., SL-PRS resource information), PRS conflict information (e.g., SL-PRS conflict information), PRS configuration information (e.g., SL-PRS configuration information), PRS scheduling information (e.g., SL-PRS scheduling information), or a combination thereof. An SL-PRS resource, such as the one or more preferred SL-PRS resources or the one or more non-preferred SL-PRS resources, may include or correspond to a PRS configuration. The PRS configuration may include a SL-PRS configuration. The SL-PRS configuration includes a number of symbols, a comb type, a comb-offset, a number of subchannels, a subchannel size, an RB, or a combination thereof. A SL-PRS conflict, such as the one or more previous SL-PRS conflicts or the one or more future conflicts, may be associated with a symbol of a slot.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2. In some implementations, transmitter 316, receiver 318, or a combination thereof may be referred to as an interface that is configured for wired communication, wireless communication, or a combination thereof.

UE 350 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. For example, memory 354 may include processor-readable code that, when executed by processor 352, causes processor 352 to preform one or more of the operations described herein. In some implementations, processor 352 includes or corresponds to one or more of receive processor 258, transmit processor 264, and controller 280, and memory 354 includes or corresponds to memory 282.

Memory 354 includes or is configured to store coordination information 355. Coordination information 355 may include or correspond to coordination information 306. Additionally, or alternatively, memory 354 may be configured to store other data or information as described at least with reference to memory 304.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 315 or base station 105. In some implementations, transmitter 356 and receiver 358 may be integrated in one or more transceivers. Additionally or alternatively, transmitter 356 or receiver 358 may include or correspond to one or more components of UE 115 described with reference to FIG. 2. In some implementations, transmitter 356, receiver 358, or a combination thereof may be referred to as an interface that is configured for wired communication, wireless communication, or a combination thereof.

UE 360 may include or correspond to UE 115, UE 315, or UE 360. UE 360 may be configured to perform one or more operations described herein at least with reference to UE 115, UE 315, or UE 360.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

A UE, such as UE 315, 350, or 360, may be configured for sidelink communication, such as SL in NR. For example, the UE may receive a SL configuration or a SL pre-configuration. The SL configuration or the SL pre-configuration may be received via radio resource control (RRC) signaling, a medium access control-control element (MAC-CE), sidelink control information (SCI), or other signaling or configuration information, as illustrative, non-limiting examples. A UE may receive the RRC signaling or the MAC-CE from a base station, such as base station 105, a core network (e.g., 130), or an LMF (e.g., 131), as an illustrative, non-limiting examples. In some implementations, the SL configuration or the SL pre-configuration may indicate a resource pool of one or more resources for position, such as subcarrier spacing (SCS), bandwidth, or location. In some implementations, the resource pool for positioning includes a Tx resource pool for mode 1 (e.g., an in-network-coverage modes), a Tx resource pool for mode 2 (e.g., an out-of-coverage mode), an Rx resource pool, or a combination thereof.

The UE may further be configured to perform a sensing procedure to generate a preferred resource set of one or more resources. For example, the UE may receive priority, a number of sub-channels, a reservation period, or a combination thereof from another UE and may perform the sensing procedure based on the priority, the number of sub-channels, the reservation period, or a combination thereof. A resource may be not be considered preferred if it overlaps with resources reserved by other UEs with RSRP above a threshold, or if it is in a slot where the UE does not expect to perform reception from another UE due to a half to duplex configuration. Additionally, or alternatively, a resource is considered non-preferred if the resource is reserved by another UE, or if the UE does not expect to perform reception from another UE due to a half to duplex configuration. The UE may consider the resource to be reserved by one or more other UEs if the resource has an RSRP greater than or equal to a (pre-) configurable threshold (to protect the UE's reception from strong interference by the one or more other UEs), or if the resource is targeted to the UE and has an RSRP less than or equal to a (pre-) configurable threshold (to protect the UE's transmission from interference).

In some implementations, the UE, such as UE 315, may transmit a message that includes or indicates coordination information, such as coordination information 306 or 355. For example, the message may include or indicate one or more preferred SL-PRS resources, one or more non-preferred resources, one or more past conflicts, one or more future conflicts, or a combination thereof. Additionally, or alternatively, the message may include or indicate one or more reservations. In some implementations, the UE may unicast, broadcast, or groupcast the message. To illustrate, the UE may broadcast or groupcast the message to one or more other devices.

In some implementations, the UE, such as UE 350, that receives the message, may determine whether or not to forward the message or a portion of the message. For example, the UE that receives the message may determine to forward the message or the portion of the message based on one or more conditions being satisfied.

The message may include a counter (or count value) that is incremented or decremented by 1 each time the message (or a portion of the message) is transmitted/forwarded. If the counter value satisfies a threshold, such as being less than or equal to the threshold or being greater than or equal to the threshold, then the message (or the portion thereof) is forwarded; otherwise, the message (or the portion thereof) is not forwarded. Additionally, or alternatively, the message may include or indicate a zone ID, a range, or a combination thereof. The zone ID may include or correspond to a UE that initially generated the message or a UE that has forwarded the message (or a portion thereof). A UE that receives the message may determine to forward the message (or the portion thereof) if the receiving UE is farther away than the zone ID, the range (e.g., a distance threshold), or a combination thereof, the message is not forwarded; otherwise, the message may be forwarded. In some implementations, a zone ID may be associated with a known location, such as a center of a zone. The message may also include a message ID, such as an information element (IE), a source device ID, a timestamp, or a combination thereof. The message ID may be generated by a device that initially generated the message. A UE that receives the message may determine to not forward the message (or the portion thereof) if the receiving UE has already received the message and forwarded the message or has already determined not to forward the message (e.g., based on a different condition); otherwise, the UE may forward the message. In some implementations, the message may include an explicit indication of whether or not the message is to be forwarded and the UE that receives the message may forward the message based on the explicit indication. It is noted that a UE that receives the message may determine whether or not to forward the message based on a single or multiple combination.

In some implementations, the coordination information included in the message may be arranged in an order. To illustrate, the coordination information may list, in order, the one or more preferred SL-PRS resources, followed by the one or more non-preferred resources, followed by the one or more past conflicts, and followed by the one or more future conflicts, as an illustrative, non-limiting example. Additionally, or alternatively, resources may be listed or ordered when multiple resources are include in the one or more preferred SL-PRS resources or the one or more non-preferred resources, or when multiple conflicts are included in the one or more past conflicts or the one or more future conflicts. Multiple preferred SL-PRS resources may be ordered based on (or according to) which is the most preferred set of resources. Multiple non-preferred SL-PRS resources may be ordered based on (or according to) which is the most non-preferred set of resources. Multiple past conflicts may be ordered based on (or according to) which is was the most severe past conflict. Multiple future conflicts, such as periodic conflicts or one shot conflicts, may be ordered based on (or according to) which is was the most severe future conflict.

A UE that receives the message including the coordination information may determine which resource to try to reserve in the future, may forward a portion or an entirety of the coordination information, or a combination thereof. In some implementations, the UE that forwards the coordination information (or a portion thereof) may include the coordination information in a new message or package that include other similar information received from one or more UEs. For example, the new message (e.g., a forwarding message) may include first coordination information received from a first UE and second coordination information received from a second UE. In some implementations, the forwarding message may include a portion of the first coordination information and a portion of the second coordination information. To illustrate, the UE may concatenate the first coordination and the second coordination information to generate the forwarding message. In some implementations, the portion of the first coordination information and the portion of the second coordination information may include the same type of information, such as preferred SL-PRS resources or non-preferred SL-PRS resources, as illustrative, non-limiting examples. Additionally, or alternatively, the portion of the first coordination information, the portion of the second coordination information, or a combination thereof may include information that is identified as or determined to be high priority.

In some implementations, a severity of a past conflict or a future conflict may be indicated based on a severity value, such as a value between 0 and 3, where a lower value indicates no conflict or a low conflict, and a higher value indicates a more conflicted resource. The severity may be determined based on RSRP, a percentage of overlap (with another resource), SINR, another metric or relative to other resources, or a combination thereof. In some implementations, a windowing technique may be used to identify past conflicts, such as past conflicts that occurred within a time period before transmission of a message. In some implementations, a severity of a future conflict may be determined based on whether a resource is periodic, whether a known conflict is present, or whether the resource is a one-shot PRS conflict (e.g., aperiodic), such as a one-shot SL-PRS conflict.

In some implementations, for a UE that receives the message (including the coordination information) to determine whether or not to forward at least a portion of the message, a counter number threshold or a range threshold (e.g., distance threshold) may be defined in a standard, provided by an LMF (e.g., 131) in a configuration message or AD message, negotiated between UEs, configured by an application layer, based on a priority of a position session, or priority of a reservation. Additionally, or alternatively, in some implementations, each reservation, each one or more preferred SL-PRS resources, each one or more non-preferred resources, each one or more past conflicts, or each one or more future conflicts may have its own unique ID or initial-source-ID to enable the UE that receives the message from duplicate forwarding (e.g., unicasting, broadcasting, or groupcasting) the message. For example, the UE that receives the message may be configured to transmit (e.g., unicasting, broadcasting, or groupcasting) only once per unique ID or initial-source-ID (e.g., UE device ID).

In some implementations, a UE that receives the message (including the coordination information) may determine whether an RSRP, an SINR, or an SNR associated with the received message is less than or equal to a threshold. If the RSRP, the SINR, or the SNR associated with the received message is less than or equal to the threshold, the UE may forward the message. Accordingly, a UE that receives the message and is relatively far away from a source of a transmission of the message, will forward the coordination information of the message, whereas the UE that is nearby the source of the transmission UE may not patriciate in forwarding (e.g., broadcasting) the message. Additionally, or alternatively, a UE that receives the message that includes a zone-ID greater than or equal to a threshold from a zone-ID of the UE or a position of the UE, may forward the message. Accordingly, a UE that receives the message and is relatively far away from a source of a transmission of the message, will forward the coordination information of the message, whereas the UE that is nearby the source of the transmission UE may not patriciate in forwarding (e.g., broadcasting) the message. Additionally, or alternatively, in some implementations, a UE that receives the message may determine whether or not the UE is expected to forward or broadcast the message. For example, the UE may determine that the UE is expected to forward or broadcast the message based on configuration information received from an LMF (e.g., 301), a configuration from an application layer, a priority of a positioning session, or a priority of a reservation. To illustrate, the UE may determine to forward or broadcast the message (or a portion thereof) based on whether a priority associated with the SL-PRS is high or a priority of the positioning session associated with the SL PRS is high.

During operation of wireless communications system 300, UE 315 is configured to generate and transmit a first message 380. First message 380 may include coordination information 306.

UE 350 may receive first message 380 may determine whether or not to forward a portion or an entirety of first message 380 or the coordination information 306 included in first message 380. Additionally, or alternatively, UE 350 may determine whether or not to include additional coordination information (e.g., 355) in the forwarded message. In some implementations, UE 350 determines to forward first message 380 and transmits second message 386 that includes at least a portion of first message 380. In some implementation, second message 386 includes coordination information 355 in addition to at least the portion of first message 380. UE 360 may receive second message 386.

In some implementations, UE 350 generates and transmits third message 388. Third message 388 may include coordination information 355 associated with SL-PRS scheduling. UE 315 may determine whether or not to forward at least a portion of (or an entirety of) the third message 388 or coordination information 355.

In some implementations, UE 315 selects a PRS resource, such as an SL-PRS resource. For example, UE 315 may select a PRS resource, such as an SL-PRS resource, based on coordination information 306, coordination information 355 received from UE 350, or a combination thereof. Additionally, or alternatively, UE 315 may generate and transmit scheduling information based on the PRS resource (e.g., the SL-PRS resource), coordination information 306, coordination information 355 received from UE 350, or a combination thereof. In some implementations, the scheduling information includes or corresponds to a reservation message configured to reserve a symbol for transmission of a PRS, such as an SL-PRS. UE 315 may transmit the PRS based on the PRS resource. For example, UE 315 may transmit the PRS during the reserved symbol. As another example, UE 315 may transmit the SL-PRS during the reserved symbol.

UE 350 may receive the scheduling information associated with the PRS, such as the SL-PRS. For example, UE 350 may receive the scheduling information from UE 315. The scheduling information may have been generated based on coordination information 306, coordination information 355, or a combination thereof. Additionally, or alternatively, UE 350 may receive the PRS, such as the SL-PRS, based on the scheduling information.

As described with reference to FIG. 1, the present disclosure provides techniques for use with sidelink positioning. For example, the techniques may advantageously support coordination information associated with sidelink positioning reference signals. Additionally, or alternatively, the techniques provide one or more conditions for forwarding the coordination information. In some aspects, the present disclosure provides techniques for improved message forwarding, improved scheduling of sidelink positioning reference signals, collision avoidance, or a combination thereof.

FIG. 4 is a flow diagram illustrating an example process 400 that supports coordination information associated with sidelink positioning reference signals according to one or more aspects. Operations of process 400 may be performed by a UE, such as UE 115 of FIG. 1 or 2, UE 315, 350, or 360 of FIG. 3, or a UE described with reference to FIG. 6. For example, example operations (also referred to as “blocks”) of process 400 may enable UE 115 to support coordination information associated with sidelink positioning reference signals.

In block 402, the UE generates first coordination information associated with SL-PRS scheduling. The first coordination information may include or correspond to coordination information 306 or 355. The first coordination information may indicate one or more preferred SL-PRS resources of the UE, one or more non-preferred SL-PRS resources of the UE, one or more previous SL-PRS conflicts identified by the UE, one or more future SL-PRS conflicts identified by the UE, or a combination thereof. A PRS resource, such as the one or more preferred SL-PRS resources or the one or more non-preferred SL-PRS resources, may include or correspond to a PRS configuration, such as an SL-PRS configuration. The PRS configuration may include a SL-PRS configuration. The SL-PRS configuration may include a number of symbols, a comb type, a comb-offset, a number of subchannels, a subchannel size, an RB, or a combination thereof. An SL-PRS conflict, such as the one or more previous SL-PRS conflicts or the one or more future conflicts, may be associated with a symbol of a slot. Additionally, or alternatively, the first coordination information may indicate one or more reservations for SL communication. The UE may determine the one or more preferred SL-PRS resource, the one or more non-preferred SL-PRS resources, the one or more previous SL-PRS conflicts, the one or more future SL-PRS conflicts, one or more reservations for the SL communication, or a combination thereof.

In some implementations, the one or more preferred SL-PRS resources include multiple preferred SL-PRS resources arranged based on priority, the one or more non-preferred SL-PRS resources include multiple non-preferred SL-PRS resources arranged based on priority, or a combination thereof. In some implementations, the one or more previous SL-PRS conflicts may be determined based on a signal quality, a percentage of overlap, a signal strength, or a combination. Additionally, or alternatively, the one or more future SL-PRS conflicts may be determined based on one or more reservations, a percentage of overlap, or a combination thereof. In some other implementations, the one or more previous SL-PRS conflicts include multiple previous SL-PRS conflicts arranged based on severity, the one or more future SL-PRS conflicts include multiple future SL-PRS conflicts arranged based on severity, or a combination thereof.

In block 404, the UE transmits a first message including the first coordination information. In some implementations, the UE may perform one or more operations as described in the appended claims. The first message may include or correspond to the first message 380, the second message 386, or the third message 388. The first message may be transmitted as a unicast transmission, a broadcast transmission, or a groupcast transmission. In some implementations, the first message is transmitted as the broadcast transmission or the groupcast transmission.

In some implementations, the first message includes a forwarding count value, a zone ID associated with the UE (or another UE), a range indicator, a message ID, or a combination thereof. The count value may be associated with a number of times at least a portion of (or the entirety of) the coordination information is forwardable by a set one or more device. The zone ID may include a zone ID of the UE. The range indicator may indicate a range threshold. The message ID may include a unique message ID generated by the UE. In some implementations, the message ID is based on a device identifier of the UE, a timestamp, or a combination thereof.

In some implementations, the UE receives scheduling information associated with a PRS, such as an SL-PRS. For example, the UE may receive the scheduling information from another UE. The scheduling information generated based on the first coordination information. Additionally, or alternatively, the UE may receive the PRS, such as the SL-PRS, based on the scheduling information.

In some implementations, the UE selects a PRS resource, such as an SL-PRS resource. For example, the UE may select a PRS resource (e.g., a SL-PRS resource) based on the first coordination information, coordination information received from another UE, or a combination thereof. Additionally, or alternatively, the UE may generate and transmit scheduling information based on the PRS resource (e.g., the SL-PRS resource), the first coordination information, the coordination information received from the other UE, or a combination thereof. In some implementations, the scheduling information includes or corresponds to a reservation message configured to reserve a symbol for transmission of a PRS, such as an SL-PRS. The UE may transmit the PRS based on the PRS resource. For example, the UE may transmit the PRS during the reserved symbol. In some implementations, the UE may transmit the SL-PRS based on the SL-PRS resource. For example the UE may transmit the SL-PRS during the reserved symbol.

In some implementations, the UE receive a second message including second coordination information associated with the SL-PRS scheduling. The second message may include or correspond to first message 380, second message 386, or third message 388. The second coordination information may include or correspond to coordination information 306 or 308. The UE may determine whether to forward at least a portion of (or an entirety of) the second message or the second coordination information. The second message or the second coordination information may include forwarding information, such as a forwarding count value, a zone ID associated with a UE that generated or is the source of the second coordination information, a range indicator, a message ID, an explicit forwarding indicator, or a combination thereof.

The UE may determine whether or not to forward the portion or the entirety of the second message or the second coordination information based on the forwarding information. Additionally, or alternatively, the UE may determine whether or not to forward the portion or the entirety of the second message or the second coordination information based on a count value threshold, a range threshold, or a combination thereof. The count value threshold, the range threshold, or a combination thereof may be defined by a standard, received from an LMF, negotiated between multiple UEs, or configured by an application layer.

In some implementations, to determine whether or not to forward the portion or the entirety of the second message or the second coordination information, the UE may perform a comparison based on the count value and a count value threshold, the zone ID and a range threshold, or a combination thereof. Additionally, or alternatively, to determine whether or not to forward the portion or the entirety of the second message or the second coordination information, the UE may determine whether the message ID and another message having the same message ID was previously transmitted by the UE or whether the other message was previously determined to not be forwarded by the UE. Additionally, or alternatively, to determine whether or not to forward the portion or the entirety of the second message or the second coordination information, the UE may determine a signal strength associated with the second message and perform a comparison based on the signal strength and a signal strength threshold. To illustrate, the UE may determine to forward the portion or the entirety of the second message or the second coordination information based on the signal strength being less than or equal to the signal strength threshold. Additionally, or alternatively, to determine whether or not to forward the portion or the entirety of the second message or the second coordination information, the UE may perform a comparison between the zone ID of the second message and a zone ID associated with the UE. To illustrate, the UE may determine to forward the portion or the entirety of the second message or the second coordination information based on the zone ID of the second message and a zone ID associated with the UE being different.

Additionally, or alternatively, to determine whether or not to forward the portion or the entirety of the second message or the second coordination information, the UE may perform a comparison based on the zone ID and a range threshold. To illustrate, the UE may determine to forward the portion or the entirety of the second message or the second coordination information based on a distance between the UE and location associated with the zone ID being greater than or equal to the range threshold. As another example, the UE may determine to forward the portion or the entirety of the second message or the second coordination information based on a distance between the UE and location associated with the zone ID being less than or equal to the range threshold. To illustrate, the UE may determine to forward the portion or the entirety of the second message or the second coordination information based on the zone ID of a source device that generated the second control information or of a device that transmitted the second message to forwarded the second control information to the UE. Additionally, or alternatively, to determine whether or not to forward the portion or the entirety of the second message or the second coordination information, the UE may determine to forward the portion or the entirety of the second message or the second coordination information based on whether a priority associated with the SL-PRS is high or a priority of a positioning session associated with the SL PRS is high.

In some implementations, the UE receives a third message including third coordination information associated with the SL-PRS scheduling. The UE may determine whether or not to forward at least a portion of (or an entirety of) the second message or the second coordination information, at least a portion of (or an entirety of) the third message or the third coordination information, or a combination thereof. In some implementations, the UE generates a forwarding message that includes the portion of (or the entirety of) the second message or the second coordination information, the portion of (or the entirety of) the third message or the third coordination information, or a combination thereof. The forwarding message may also include the first message, a portion or an entirety of the first message or the first coordination information. The UE may transmit the forwarding message.

FIG. 5 is a flow diagram illustrating an example process 500 that supports coordination information associated with sidelink positioning reference signals according to one or more aspects. Operations of process 500 may be performed by a UE, such as UE 115 of FIG. 1 or 2, UE 315, 350, or 360 of FIG. 3, or a UE described with reference to FIG. 6. For example, example operations (also referred to as “blocks”) of process 500 may enable UE 115 to support coordination information associated with sidelink positioning reference signals.

In block 502, the UE receives a first message including first coordination information associated with SL-PRS scheduling. The first message may include or correspond to first message 380, second message 386, or third message 388. The first coordination information may include or correspond to coordination information 306 or 355. The first coordination information may indicate one or more preferred SL-PRS resources of another UE, one or more non-preferred SL-PRS resources of the other UE, one or more previous SL-PRS conflicts identified by the other UE, one or more future SL-PRS conflicts identified by the other UE, or a combination thereof. An SL-PRS resource, such as the one or more preferred SL-PRS resources or the one or more non-preferred SL-PRS resources, may include or correspond to a PRS configuration, such as an SL-PRS configuration. The PRS configuration may include a SL-PRS configuration. The SL-PRS configuration includes a number of symbols, a comb type, a comb-offset, a number of subchannels, a subchannel size, an RB, or a combination thereof. An SL-PRS conflict, such as the one or more previous SL-PRS conflicts or the one or more future conflicts, may be associated with a symbol of a slot. Additionally, or alternatively, the first coordination information may indicate one or more reservations for SL communication.

In block 504, the UE determine whether to forward at least a portion of the first message (or the first coordination information) based on forwarding information included in the first message. The forwarding information includes a forwarding count value, a zone ID associated with the UE (or a UE associated with the first message), a range indicator, a message ID, an explicit forwarding indicator, or a combination thereof.

The UE may determine whether or not to forward the portion or the entirety of the first message or the first coordination information based on the forwarding information. Additionally, or alternatively, the UE may determine whether or not to forward the portion or the entirety of the first message or the first coordination information based on a count value threshold, a range threshold, or a combination thereof. The count value threshold, the range threshold, or a combination thereof may be defined by a standard, received from an LMF, negotiated between multiple UEs, or configured by an application layer.

In some implementations, to determine whether or not to forward the portion or the entirety of the first message or the first coordination information, the UE may perform a comparison based on the count value and a count value threshold, the zone ID and a range threshold, or a combination thereof. Additionally, or alternatively, to determine whether or not to forward the portion or the entirety of the first message or the first coordination information, the UE may determine whether the message ID and another message having the same message ID was previously transmitted by the UE or whether the other message was previously determined to not be forwarded by the UE. Additionally, or alternatively, to determine whether or not to forward the portion or the entirety of the first message or the first coordination information, the UE may determine a signal strength associated with the first message and perform a comparison based on the signal strength and a signal strength threshold. To illustrate, the UE may determine to forward the portion or the entirety of the first message or the first coordination information based on the signal strength being less than or equal to the signal strength threshold. Additionally, or alternatively, to determine whether or not to forward the portion or the entirety of the first message or the first coordination information, the UE may perform a comparison between the zone ID of the first message and a zone ID associated with the UE. To illustrate, the UE may determine to forward the portion or the entirety of the first message or the first coordination information based on the zone ID of the first message and a zone ID associated with the UE being different.

Additionally, or alternatively, to determine whether or not to forward the portion or the entirety of the first message or the first coordination information, the UE may perform a comparison based on the zone ID and a range threshold. To illustrate, the UE may determine to forward the portion or the entirety of the first message or the first coordination information based on a distance between the UE and location associated with the zone ID being greater than or equal to the range threshold. As another example, the UE may determine to forward the portion or the entirety of the first message or the first coordination information based on a distance between the UE and location associated with the zone ID being less than or equal to the range threshold. To illustrate, the UE may determine to forward the portion or the entirety of the first message or the first coordination information based on the zone ID of a source device that generated the first control information or of a device that transmitted the first message to forwarded the first control information to the UE. Additionally, or alternatively, to determine whether or not to forward the portion or the entirety of the first message or the first coordination information, the UE may determine to forward the portion or the entirety of the first message or the first coordination information based on whether a priority associated with the SL-PRS is high or a priority of a positioning session associated with the SL PRS is high.

In some implementations, the UE selects a PRS resource, such as an SL-PRS resource. For example, the UE may select a PRS resource, such as an SL-PRS resource, based on the first coordination information, other coordination information received from another UE, or a combination thereof. Additionally, or alternatively, the UE may generate and transmit scheduling information based on the PRS resource (e.g., the SL-PRS resource), the first coordination information, the coordination information received from the other UE, or a combination thereof. In some implementations, the scheduling information includes or corresponds to a reservation message configured to reserve a symbol for transmission of a PRS, such as a SL-PRS. The UE may transmit the PRS based on the PRS resource. For example, the UE may transmit the PRS during the reserved symbol. In some implementations, the UE may transmit the SL-PRS based on the SL-PRS resource. For example the UE may transmit the SL-PRS during the reserved symbol.

In some implementations, the UE receives a second message including second coordination information associated with the SL-PRS scheduling. The UE may determine whether or not to forward at least a portion of (or an entirety of) the first message or the first coordination information, at least a portion of (or an entirety of) the second message or the second coordination information, or a combination thereof. In some implementations, the UE generates a forwarding message that includes the portion of (or the entirety of) the first message or the first coordination information, the portion of (or the entirety of) the second message or the second coordination information, or a combination thereof. The forwarding message may also include third coordination information of or generated by the UE. The UE may transmit the forwarding message.

FIG. 6 is a block diagram of an example UE 600 that supports coordination information associated with sidelink positioning reference signals to one or more aspects. UE 600 may be configured to perform operations, including the blocks of a process described with reference to FIG. 4 or 5. In some implementations, UE 600 includes the structure, hardware, and components shown and described with reference to UE 115 of FIG. 1 or 2, or UE 315, 350, or 360 of FIG. 3. For example, UE 600 includes controller 280, which operates to execute logic or computer instructions stored in memory 282, as well as controlling the components of UE 600 that provide the features and functionality of UE 600. UE 600, under control of controller 280, transmits and receives signals via wireless radios 601a-r and antennas 252a-r. Wireless radios 601a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include sidelink logic 602 and forwarding logic 603. Sidelink logic 602 may be configured to generate coordination information, such as coordination information 306 or 355. Forwarding logic 603 may be configured to determine whether or not to forward at least a portion of coordination, such as coordination information 306 or 355. UE 600 may receive signals from or transmit signals to one or more network entities, such as base station 105 of FIGS. 1 and 2, another UE, or another device (e.g., an IoT device).

The following examples are illustrative only and may be combined with aspects of other implementation or teachings described herein, without limitation.

In some aspects, techniques for supporting coordination information associated with sidelink positioning reference signals may include additional aspects, such as any single aspect or any combination of aspects described below or in connection with one or more other processes or devices described elsewhere herein. In a first aspect, techniques for coordination information associated with sidelink positioning reference signals may include generating first coordination information associated with SL-PRS scheduling. The first coordination information indicates one or more preferred SL-PRS resources of a first UE, one or more non-preferred SL-PRS resources of the UE, one or more previous SL-PRS conflicts identified by the UE, one or more future SL-PRS conflicts identified by the UE, or a combination thereof. The techniques further include transmitting a first message including the first coordination information. In some examples, the techniques in the first aspect may be implemented in a method or process. In some other examples, the techniques of the first aspect may be implemented in a wireless communication device such as a UE, a component of a UE, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In a second aspect, in combination with the first aspect, the first coordination information indicates the one or more preferred SL-PRS resources of the first UE or the one or more non-preferred SL-PRS resources of the first UE.

In a third aspect, in combination with the first aspect or the second the second aspect, the first coordination information indicates the one or more previous SL-PRS conflicts identified by the first UE or the one or more future SL-PRS conflicts identified by the first UE.

In a fourth aspect, in combination with one or more of the first aspect through the third aspect, the techniques further include receiving scheduling information associated with an SL-PRS, the scheduling information generated based on the first coordination information.

In a fifth aspect, in combination with the fourth aspect, the techniques further include receiving the SL-PRS based on the scheduling information.

In a sixth aspect, in combination with one or more of the first aspect through the fifth aspect, an SL-PRS resource is associated with an SL-PRS configuration that includes a SL-PRS configuration, the SL-PRS configuration includes a number of symbols, a comb type, a comb-offset, a number of subchannels, a subchannel size, an RB, or a combination thereof.

In a seventh aspect, in combination with one or more of the first aspect through the sixth aspect, an SL-PRS conflict is associated with a symbol of a slot.

In an eighth aspect, in combination with one or more of the second aspect through the seventh aspect, the one or more preferred SL-PRS resources include multiple preferred SL-PRS resources arranged based on priority.

In a ninth aspect, in combination with one or more of the second aspect through the eighth aspect, the one or more non-preferred SL-PRS resources include multiple non-preferred SL-PRS resources arranged based on priority.

In a tenth aspect, in combination with one or more of the third aspect through the ninth aspect, the one or more previous SL-PRS conflicts determined based on a signal quality, a percentage of overlap, a signal strength, or a combination.

In an eleventh aspect, in combination with one or more of the third aspect through the ninth aspect, the one or more previous SL-PRS conflicts include multiple previous SL-PRS conflicts arranged based on severity.

In a twelfth aspect, in combination with one or more of the third aspect through the eleventh aspect, the one or more future SL-PRS conflicts determined based on one or more reservations, a percentage of overlap, or a combination thereof.

In a thirteenth aspect, in combination with one or more of the third aspect through the eleventh aspect, the one or more future SL-PRS conflicts include multiple future SL-PRS conflicts arranged based on severity.

In a fourteenth aspect, in combination with one or more of the first aspect through the thirteenth aspect, the first coordination information further indicates one or more reservations for SL communication.

In a fifteenth aspect, in combination with one or more of the first aspect through the fourteenth aspect, the first message includes a forwarding count value associated with a number of times at least a portion of the coordination information is forwardable by a set one or more device, a zone ID of the first UE, a range indicator that indicates a range threshold, a message ID based on a device identifier of the first UE and a timestamp, or a combination thereof.

In a sixteenth aspect, in combination with one or more of the first aspect through the fifteenth aspect, the techniques further include receiving a second message including second coordination information associated with the SL-PRS scheduling.

In some aspects, techniques for supporting coordination information associated with sidelink positioning reference signals may include additional aspects, such as any single aspect or any combination of aspects described below or in connection with one or more other processes or devices described elsewhere herein. In a seventeenth aspect, techniques for supporting coordination information associated with sidelink positioning reference signals may include receiving a first message including first coordination information associated with SL-PRS scheduling. The first coordination information indicates one or more preferred SL-PRS resources of a first UE, one or more non-preferred SL-PRS resources of the first UE, one or more previous SL-PRS conflicts identified by the first UE, one or more future SL-PRS conflicts identified by the first UE, or a combination thereof. The techniques further include determining whether to forward at least a portion of the first message based on forwarding information included in the first message. In some examples, the techniques in the seventeenth aspect may be implemented in a method or process. In some other examples, the techniques of the seventeenth aspect may be implemented in a wireless communication device such as a UE, a component of a UE, a network entity, or a component of a network entity. In some examples, the wireless communication device may include at least one processing unit or system (which may include an application processor, one or more processors, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include one or more means configured to perform operations described herein.

In an eighteenth aspect, in combination with the seventeenth aspect, the techniques further include transmitting a reservation message to reserve a symbol for transmission of an SL-PRS.

In a nineteenth aspect, in combination with the seventeenth aspect or the eighteenth aspect, the techniques further include transmitting the SL-PRS using an SL-PRS resource, where the symbol, the SL-PRS resource, or a combination thereof is selected based on the first coordination information.

In a twentieth aspect, in combination with one or more of the seventeenth aspect through the nineteenth aspect, the first coordination information indicates the one or more preferred SL-PRS resources of a second UE, the one or more non-preferred SL-PRS resources of the second UE, the one or more previous SL-PRS conflicts identified by the second UE, and the one or more future SL-PRS conflicts identified by the second UE.

In a twenty-first aspect, in combination with one or more of the seventeenth aspect through the twentieth aspect, the forwarding information includes a forwarding count value, a zone ID associated with the first UE or the second UE, a range indicator, a message ID, or a combination thereof.

In a twenty-second aspect, in combination with the twenty-first aspect, the techniques for determining whether to forward the portion of the first message include performing a comparison based on the forwarding count value and a count value threshold, the zone ID and a range threshold, or a combination thereof.

In a twenty-third aspect, in combination with the twenty-second aspect, the count value threshold, the range threshold, or a combination thereof is defined by a standard, received from an LMF, negotiated between multiple UEs, or configured by an application layer.

In a twenty-fourth aspect, in combination with one or more of the twenty-first aspect through the twenty-third, determining whether to forward the portion of the first message is determined based on the message ID and whether another message having the same message ID was previously transmitted by the first UE or determined to not be forwarded by the first UE.

In a twenty-fifth aspect, in combination with one or more of the twenty-first aspect through the twenty-fourth aspect, the techniques for determining whether to forward the portion of the first message include determining a signal strength associated with the first message and performing a comparison based on the signal strength and a signal strength threshold.

In a twenty-sixth aspect, in combination with the twenty-fifth aspect, the portion determined to be forwarded based on the signal strength being less than or equal to the signal strength threshold.

In a twenty-seventh aspect, in combination with one or more of the twenty-first aspect through the twenty-sixth aspect, the techniques for determining whether to forward the portion of the first message include performing a comparison between the zone ID of the first message and a zone ID associated with the first UE.

In a twenty-eighth aspect, in combination with the twenty-seventh aspect, the portion determined to be forwarded based on the zone ID of the first message and the zone ID associated with the first UE being different.

In a twenty-ninth aspect, in combination with one or more of the twenty-first aspect through the twenty-eighth aspect, the techniques for determining whether to forward the portion of the first message include performing a comparison based on the zone ID and a range threshold, the zone ID is associated with a source device that generated the first coordination information or of a device that transmitted the first message to forwarded the first coordination information to the first UE.

In a thirtieth aspect, in combination with the twenty-ninth aspect, the portion determined to be forwarded based on a distance between the first UE and a location associated with the zone ID being greater than or equal to the range threshold.

In a thirty-first aspect, in combination with one or more of the seventeenth aspect through the thirtieth aspect, the forwarding information includes an explicit forwarding indicator.

In a thirty-second aspect, in combination with one or more of the seventeenth aspect through the thirty-first aspect, the techniques further include determining to forward the portion of the first message based on whether a priority associated with the SL-PRS is high or a priority of a positioning session associated with the SL PRS is high.

In a thirty-third aspect, in combination with one or more of the seventeenth aspect through the thirty-second aspect, the techniques further include receiving a second message including second coordination information associated with the SL-PRS scheduling.

In a thirty-fourth aspect, in combination with the thirty-third aspect, the techniques further include determining whether to forward at least the portion of the first message, at least a portion of the second message, or a combination thereof.

In a thirty-fifth aspect, in combination with the thirty-fourth aspect, the techniques further include generating a forwarding message that includes the portion of the first message, the portion of the second message, or a combination thereof.

In a thirty-sixth aspect, in combination with the thirty-fifth aspect, the techniques further include transmitting the forwarding message.

In a thirty-seventh aspect, in combination with one or more of the seventeenth aspect through the thirty-sixth aspect, the techniques further include forwarding the portion of the first message.

In a thirty-eighth aspect, in combination with one or more of the seventeenth aspect through the thirty-seventh aspect, the techniques further include forwarding an entirety of the first message.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication comprising:
generating, by a first user equipment (UE), first coordination information associated with sidelink-positioning reference signal (SL-PRS) scheduling, the first coordination information indicates one or more preferred SL-PRS resources of the first UE, one or more non-preferred SL-PRS resources of the first UE, one or more previous SL-PRS conflicts identified by the first UE, one or more future SL-PRS conflicts identified by the first UE, or a combination thereof; and
transmitting a first message including the first coordination information.

2. The method of claim 1, wherein:
the first message is transmitted as a unicast transmission, a broadcast transmission, or a groupcast transmission; and
the first coordination information indicates the one or more preferred SL-PRS resources of the first UE, the one or more non-preferred SL-PRS resources of the first UE, the one or more previous SL-PRS conflicts identified by the first UE, and the one or more future SL-PRS conflicts identified by the first UE.

3. The method of claim 2, wherein:
the one or more preferred SL-PRS resources include multiple preferred SL-PRS resources arranged based on priority;
the one or more non-preferred SL-PRS resources include multiple non-preferred SL-PRS resources arranged based on priority;
the one or more previous SL-PRS conflicts determined based on a signal quality, a percentage of overlap, a signal strength, or a combination;
the one or more future SL-PRS conflicts determined based on one or more reservations, a percentage of overlap, or a combination thereof, or a combination thereof.

4. The method of claim 2, wherein:
the one or more previous SL-PRS conflicts include multiple previous SL-PRS conflicts arranged based on severity;
the one or more future SL-PRS conflicts include multiple future SL-PRS conflicts arranged based on severity; or
a combination thereof.

5. The method of claim 1, further comprising:
receiving scheduling information associated with an SL-PRS, the scheduling information generated based on the first coordination information; and
receiving the SL-PRS based on the scheduling information.

6. The method of claim 1, wherein:
an SL-PRS resource is associated with an SL-PRS configuration that includes a SL-PRS configuration, the SL-PRS configuration includes a number of symbols, a comb type, a comb-offset, a number of subchannels, a subchannel size, a reference block (RB), or a combination thereof;
an SL-PRS conflict is associated with a symbol of a slot; or
a combination thereof.

7. The method of claim 1, wherein the first coordination information further indicates one or more reservations for sidelink (SL) communication.

8. The method of claim 1, wherein the first message includes a forwarding count value associated with a number of times at least a portion of the first coordination information is forwardable by a set one or more device, a zone ID of the first UE, a range indicator that indicates a range threshold, a message ID based on a device identifier of the first UE and a timestamp, or a combination thereof.

9. The method of claim 1, further comprising receiving a second message including second coordination information associated with the SL-PRS scheduling.

10. A user equipment (UE) comprising:
a memory storing processor-readable code; and
at least one processor coupled to the memory, the at least one processor configured to execute the processor-readable code to cause the at least one processor to:
generate first coordination information associated with sidelink-positioning reference signal (SL-PRS) scheduling, the first coordination information indicates one or more preferred SL-PRS resources of the UE, one or more non-preferred SL-PRS resources of the UE, one or more previous SL-PRS conflicts identified by the UE, one or more future SL-PRS conflicts identified by the UE, or a combination thereof; and
initiate transmission of a first message including the first coordination information.

11. The UE of claim 10, wherein:
the first coordination information further indicates one or more reservations for sidelink (SL) communication; and
the first message includes a forwarding count value associated with a number of times at least a portion of the first coordination information is forwardable by a set one or more device, a zone ID of the UE, a range indicator that indicates a range threshold, a message ID based on a device identifier of the UE and a timestamp, or a combination thereof.

12. The UE of claim 10, wherein:
the first message is transmitted as a unicast transmission, a broadcast transmission, or a groupcast transmission; and
the first coordination information indicates the one or more preferred SL-PRS resources of the UE, the one or more non-preferred SL-PRS resources of the UE, the one or more previous SL-PRS conflicts identified by the UE, and the one or more future SL-PRS conflicts identified by the UE.

13. The UE of claim 12, wherein:
the one or more preferred SL-PRS resources include multiple preferred SL-PRS resources arranged based on priority, and
the one or more non-preferred SL-PRS resources include multiple non-preferred SL-PRS resources arranged based on priority.

14. The UE of claim 12, wherein:
the one or more previous SL-PRS conflicts determined based on a signal quality, a percentage of overlap, a signal strength, or a combination, and
the one or more future SL-PRS conflicts determined based on one or more reservations, a percentage of overlap, or a combination thereof.

15. The UE of claim 12, wherein:
the one or more previous SL-PRS conflicts include multiple previous SL-PRS conflicts arranged based on severity; and
the one or more future SL-PRS conflicts include multiple future SL-PRS conflicts arranged based on severity.

16. A method of wireless communication comprising:
receiving, by a first user equipment (UE), a first message including first coordination information associated with sidelink-positioning reference signal (SL-PRS) scheduling, the first coordination information indicates one or more preferred SL-PRS resources of the first UE, one or more non-preferred SL-PRS resources of the first UE, one or more previous SL-PRS conflicts identified by the first UE, one or more future SL-PRS conflicts identified by the first UE, or a combination thereof; and
determining whether to forward at least a portion of the first message based on forwarding information included in the first message.

17. The method of claim 16, further comprising:
transmitting a reservation message to reserve a symbol for transmission of an SL-PRS; and
transmitting the SL-PRS using an SL-PRS resource, wherein the symbol, the SL-PRS resource, or a combination thereof is selected based on the first coordination information.

18. The method of claim 16, wherein the forwarding information includes a forwarding count value, a zone ID associated with the first UE or a second UE, a range indicator, a message ID, or a combination thereof.

19. The method of claim 18, wherein:
determining whether to forward the portion of the first message includes performing a comparison based on the forwarding count value and a count value threshold, the zone ID and a range threshold, or a combination thereof; and
the count value threshold, the range threshold, or a combination thereof is defined by a standard, received from a location management function (LMF), negotiated between multiple UEs, or configured by an application layer.

20. The method of claim 18, wherein determining whether to forward the portion of the first message is determined based on the message ID and whether another message having the same message ID was previously transmitted by the first UE or determined to not be forwarded by the first UE.

21. The method of claim 18, wherein:
determining whether to forward the portion of the first message includes determining a signal strength associated with the first message and performing a comparison based on the signal strength and a signal strength threshold, the portion determined to be forwarded based on the signal strength being less than or equal to the signal strength threshold;
determining whether to forward the portion of the first message includes performing a comparison between the zone ID of the first message and a zone ID associated with the first UE, the portion determined to be forwarded based on the zone ID of the first message and the zone ID associated with the first UE being different; or
determining whether to forward the portion of the first message includes performing a comparison based on the zone ID and a range threshold, the zone ID is associated with a source device that generated the first coordination information or of a device that transmitted the first message to forwarded the first coordination information to the first UE, the portion determined to be forwarded based on a distance between the first UE and a location associated with the zone ID being greater than or equal to the range threshold.

22. The method of claim 16, wherein the forwarding information includes an explicit forwarding indicator.

23. The method of claim 16, further comprising determining to forward the portion of the first message based on whether a priority associated with the SL-PRS is high or a priority of a positioning session associated with the SL PRS is high.

24. The method of claim 16, further comprising:
receiving a second message including second coordination information associated with the SL-PRS scheduling;
determining whether to forward at least the portion of the first message, at least a portion of the second message, or a combination thereof;
generating a forwarding message that includes the portion of the first message, the portion of the second message, or a combination thereof; and
transmitting the forwarding message.

25. A user equipment (UE) comprising:
a memory storing processor-readable code; and
at least one processor coupled to the memory, the at least one processor configured to execute the processor-readable code to cause the at least one processor to:
receive a first message including first coordination information associated with sidelink-positioning reference signal (SL-PRS) scheduling, the first coordination information indicates one or more preferred SL-PRS resources of the UE, one or more non-preferred SL-PRS resources of the UE, one or more previous SL-PRS conflicts identified by the UE, one or more future SL-PRS conflicts identified by the UE, or a combination thereof; and
determine whether to forward at least a portion of the first message based on forwarding information included in the first message.

26. The UE of claim 25, wherein the forwarding information includes a forwarding count value, a zone ID associated with the UE, a range indicator, a message ID, or a combination thereof.

27. The UE of claim 26, wherein, to determine whether to forward the portion of the first message, the at least one processor is further configured to execute the processor-readable code to cause the at least one processor to:
performing a comparison based on the forwarding count value and a count value threshold, the zone ID and a range threshold, or a combination thereof, the count value threshold, the range threshold, or a combination thereof are defined by a standard, received from a location management function (LMF), negotiated between multiple UEs, or configured by an application layer.

28. The UE of claim 26, wherein, to determine whether to forward the portion of the first message, the at least one processor is further configured to execute the processor-readable code to cause the at least one processor to:
determining whether to forward the portion of the first message includes determining a signal strength associated with the first message and performing a comparison based on the signal strength and a signal strength threshold, the portion determined to be forwarded based on the signal strength being less than or equal to the signal strength threshold.

29. The UE of claim 26, wherein, to determine whether to forward the portion of the first message, the at least one processor is further configured to execute the processor-readable code to cause the at least one processor to:
determining whether to forward the portion of the first message includes performing a comparison between the zone ID of the first message and a zone ID associated with the UE, the portion determined to be forwarded based on the zone ID of the first message and a zone ID associated with the UE being different.

30. The UE of claim 26, wherein, to determine whether to forward the portion of the first message, the at least one processor is further configured to execute the processor-readable code to cause the at least one processor to:
determining whether to forward the portion of the first message includes performing a comparison based on the zone ID and a range threshold, the zone ID is associated with a source device that generated the first coordination information or of a device that transmitted the first message to forwarded the first coordination information to the UE, the portion determined to be forwarded based on a distance between the UE and location associated with the zone ID being greater than or equal to the range threshold.
